(19) United States
(12) Patent Application Publication
(10) Pub. No.: US 2013/0152467 A1
(43) Pub. Date: Jun. 20, 2013

(54) Watering system for planter combination background of the invention

(71) Applicant: Cheng Chung Chang, Taichung (TW)

(72) Inventor: Cheng Chung Chang, Taichung (TW)

(21) Appl. No.: 13/374,322

(22) Filed: Dec. 20, 2011

(51) Int. Cl. A01G 9/02

(52) U.S. Cl. 47/82; 47/79

(57) ABSTRACT

A planter device includes an upper planter pot and a lower planter pot attached to a supporting device, the planter pots each include a port coupled to a tube, the upper planter pot includes an outlet conduit coupled to the tube of the lower planter pot, a water supplying pipe is connected to a coupler for supplying a water to the tube and the port of the upper planter pot, the coupler includes a bore for supplying the water from the water supplying pipe to the tube, and includes an outlet channel communicative with the bore of the coupler for supplying the water out of the coupler and into the upper planter pot and for easily and automatically watering the plants contained in the planter pots and for economizing the water.

### BACKGROUND OF THE INVENTION

1. Field of the Invention

The present invention relates to a planter combination, and more particularly to a planter combination including a number of containers or planter pots and including a watering system for easily and automatically watering the plants contained in the planter pots and for economizing the water.

2. Description of the Prior Art

Typical planters comprise one or more containers or planter pots each including a chamber formed therein for receiving or containing the plants.

For example, U.S. Pat. No. 4,145,841 to Woolpert discloses one of the typical extendible planters comprising an upper planter expanded horizontally and vertically by connecting to a lower planter.

However, the plants received or contained in the upper and the lower planters may not be easily and automatically supplied with the water, or the water may not be easily and automatically supplied to the upper and the lower planters.

U.S. Pat. No. 5,020,275 to Bednarzik, and U.S. Pat. No. 5,596,839 to Ellis-El disclose several other typical planters comprising a container or planter pot to hold conventional plants with soil, and a method and apparatus for automatically watering and moderating the ambient temperature of a plurality of potted plants.

However, the automatically watering and moderating method and apparatus may not be used for suitably watering the plants contained in the planter pots that are disposed up and down relative to each other.

U.S. Pat. No. 5,509,232 to Laubsch, and U.S. Pat. No. 5,570,785 to Honkawa disclose several further typical planters each also comprising a container or planter pot to hold conventional plants with soil or the like.

However, the plants contained in the planter pots that are disposed up and down relative to each other may not be suitably supplied with the water, or it will be difficult for the user to water the plants contained in the planter pots that are disposed up and down relative to each other.

The present invention has arisen to mitigate and/or obviate the afore-described disadvantages of the conventional planter devices or members.

### SUMMARY OF THE INVENTION

The primary objective of the present invention is to provide a planter combination including a number of containers or planter pots and including a watering system for easily and automatically watering the plants contained in the planter pots and for economizing the water.

The other objective of the present invention is to provide a planter combination including a watering system for easily and automatically watering the plants contained in the planter pots that are disposed up and down relative to each other.

In accordance with one aspect of the invention, there is provided a planter combination comprising a supporting device, an upper planter pot attached to the supporting device and including a port extended from a bottom wall, a tube attached to the port of the upper planter pot, a water supplying pipe, and a coupler connecting the water supplying pipe to the tube for supplying a water to the tube and the port of the upper planter pot, the coupler including a bore formed therein and communicative with the tube and the water supplying pipe and for allowing the water to flow from the water supplying pipe to the tube, and the coupler including an outlet channel formed therein and communicative with the bore of the coupler for supplying the water out of the coupler and into the upper planter pot.

The water supplying pipe includes an outlet aperture formed therein and directly connected to the coupler, or indirectly connected to the coupler with a mouth piece and a hose for supplying the water to the coupler.

The upper planter pot includes a bottom wall having a number of openings formed therein for allowing the water to flow out through the openings of the bottom wall, and includes a peripheral fence extended upwardly from the bottom wall and arranged around the openings of the bottom wall for forming a chamber in the planter pot and around the peripheral fence and for receiving and containing the water within the chamber of the planter pot and for allowing an excess water to flow over the peripheral fence and to selectively flow out through the openings of the bottom wall and for selectively supplying the water to the lower planter pot that is disposed below the upper ones.

A lower planter pot may further be provided and attached to the supporting device and disposed below the upper planter pot, and the lower planter pot includes a port extended from a bottom wall and connected to a second tube, and the upper planter pot includes an outlet conduit extended downwardly therefrom and connected to the second tube.

The outlet conduit of the upper planter pot includes at least one orifice formed therein for allowing the water to selectively flow out through the orifice of the outlet conduit and to flow to the lower planter pot. The upper and the lower planter pots each include a seat extended from the bottom wall, and the outlet conduit is extended from the seat.

The upper and the lower planter pots each include at least one hook member for engaging with the supporting device. The supporting device includes a number of grids provided therein for engaging with the hook member of the upper and the lower planter pots.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a planter combination in accordance with the present invention;

FIG. 2 is a partial perspective view illustrating a portion of the planter combination;

FIG. 3 is a partial exploded view of the planter combination;

FIG. 4 is another partial exploded view of the planter combination;

FIG. 5 is a bottom perspective view of a planter pot of the planter combination;

FIG. 6 is an enlarged partial perspective view of the planter pot of the planter combination;

FIG. 7 is an enlarged partial perspective view of a sprayer nozzle or coupler of the planter combination;

FIG. 8 is a partial top plan schematic view of the planter combination;

FIG. 9 is a partial cross sectional view of the planter combination taken along lines 9-9 of FIG. 8;

FIG. 10 is an enlarged partial cross sectional view of the planter combination;

FIG. 11 is another cross sectional view of the planter combination taken along lines 11-11 of FIG. 9;

FIG. 12 is a partial cross sectional view similar to FIG. 9 illustrating the operation of the planter combination;

FIG. 13 is a further partial exploded view illustrating the other arrangement of the planter combination;

FIG. 14 is a partial cross sectional view of the planter combination as shown in FIG. 13;

FIG. 15 is a bottom perspective view of a planter pot of the planter combination as shown in FIGS. 13-14;

FIG. 16 is an enlarged partial perspective view of the planter pot of the planter combination as shown in FIG. 15;

FIG. 17 is a further partial cross sectional view similar to FIG. 14 illustrating the operation of the planter combination;

FIG. 18 is a further perspective view illustrating the further arrangement of the planter combination;

FIG. 19 is a partial exploded view of the planter combination as shown in FIG. 18;

FIG. 20 is an enlarged partial perspective view of the planter pot of the planter combination as shown in FIG. 19;

FIG. 21 is a partial cross sectional view of the planter combination as shown in FIGS. 18-19, illustrating the operation of the planter combination; and

FIG. 22 is a still further partial cross sectional view of the planter combination taken along lines 22-22 of FIG. 21.

### DETAILED DESCRIPTION OF THE PREFERRED EMBODIMENT

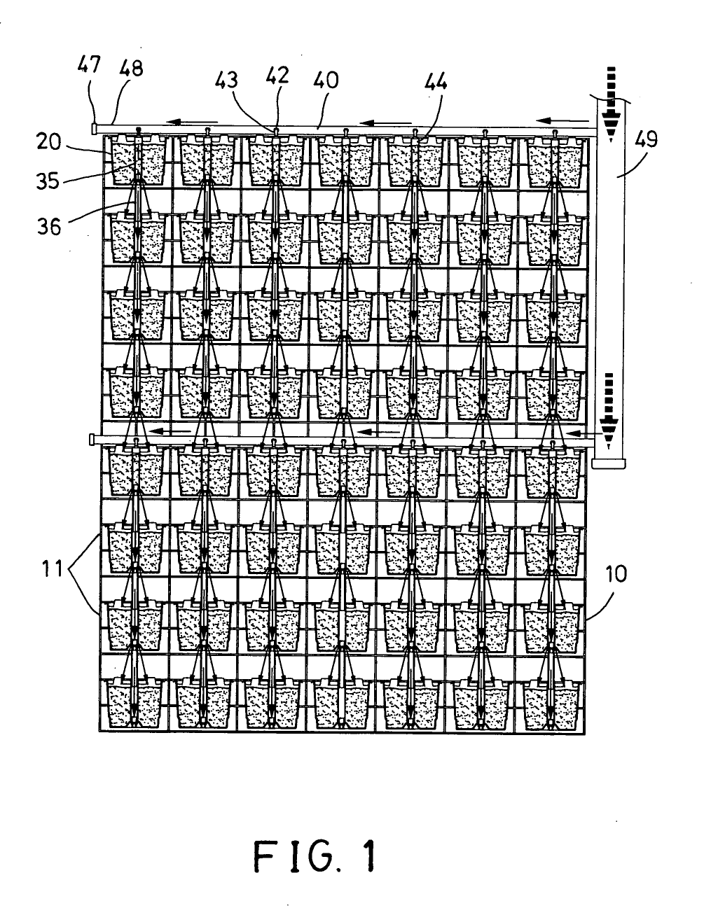

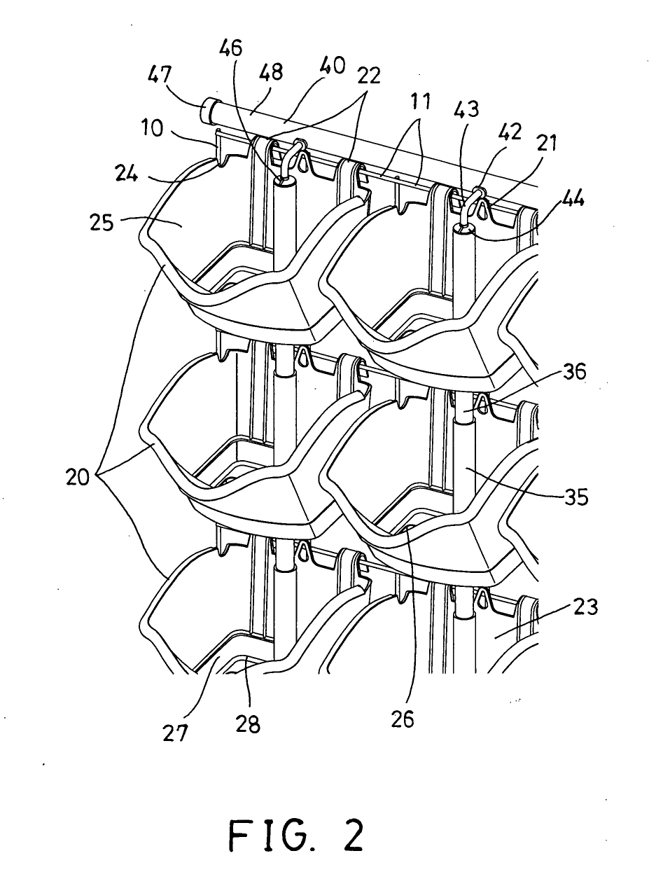

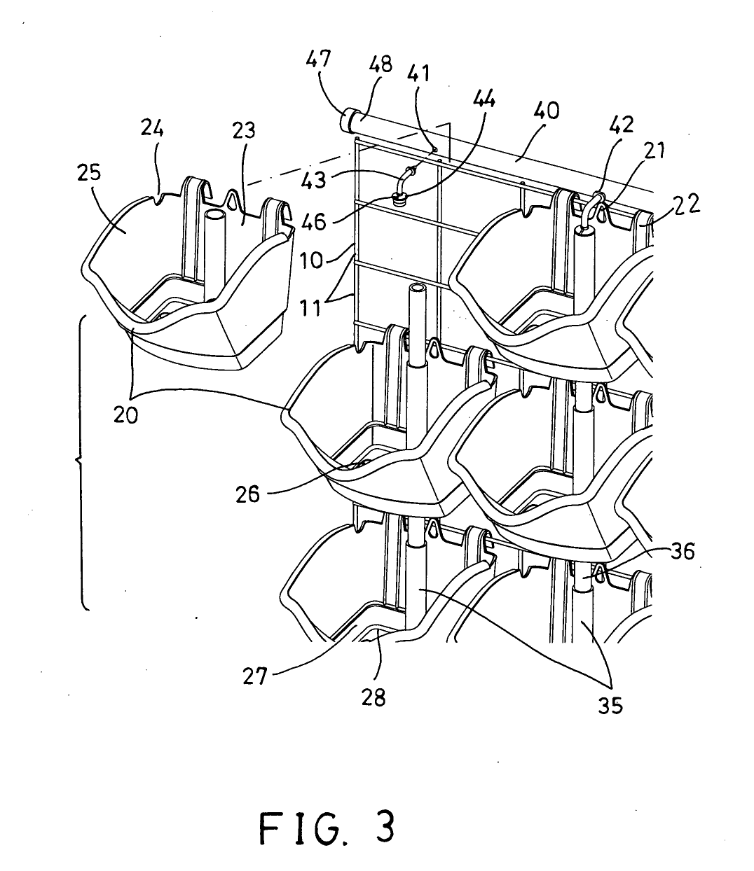

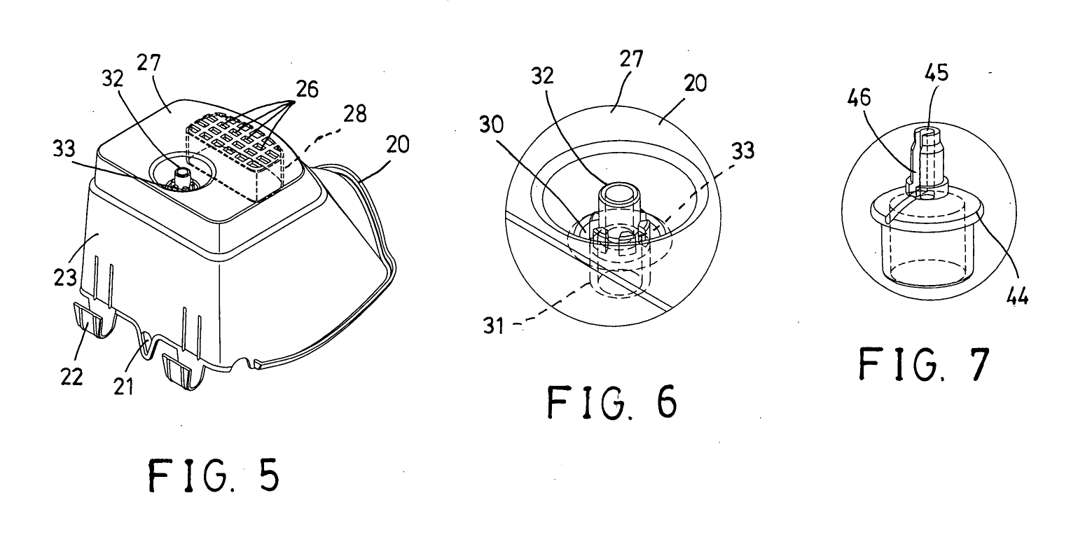

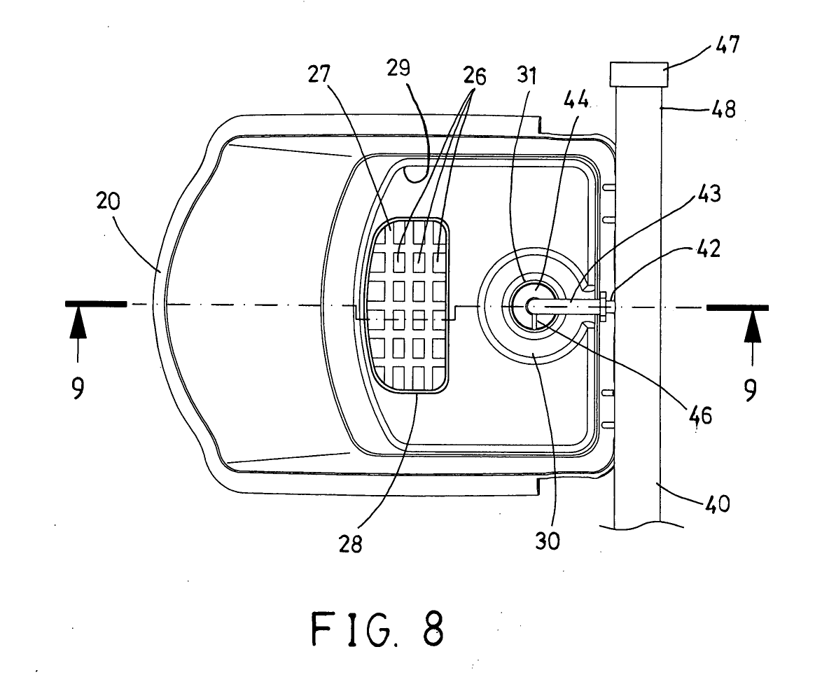

Referring to the drawings, and initially to FIGS. 1-6, a planter combination in accordance with the present invention comprises a supporting device 10, such as a net 10 having a number of grids 11 formed or provided therein (FIGS. 1-3 and 12) for hanging or supporting a number of containers or planter pots 20. For example, the planter pots 20 each include one or more key holes or ears 21 formed or provided therein for hanging purposes, and each include one or more (such as two) hook members 22 formed or provided thereon, such as extended from the rear wall 23 thereof for hanging or engaging onto the grids 11 of the supporting device 10 and for allowing the planter pots 20 to be disposed or located or arranged side by side and/or up and down relative to each other, best shown in FIGS. 1-3.

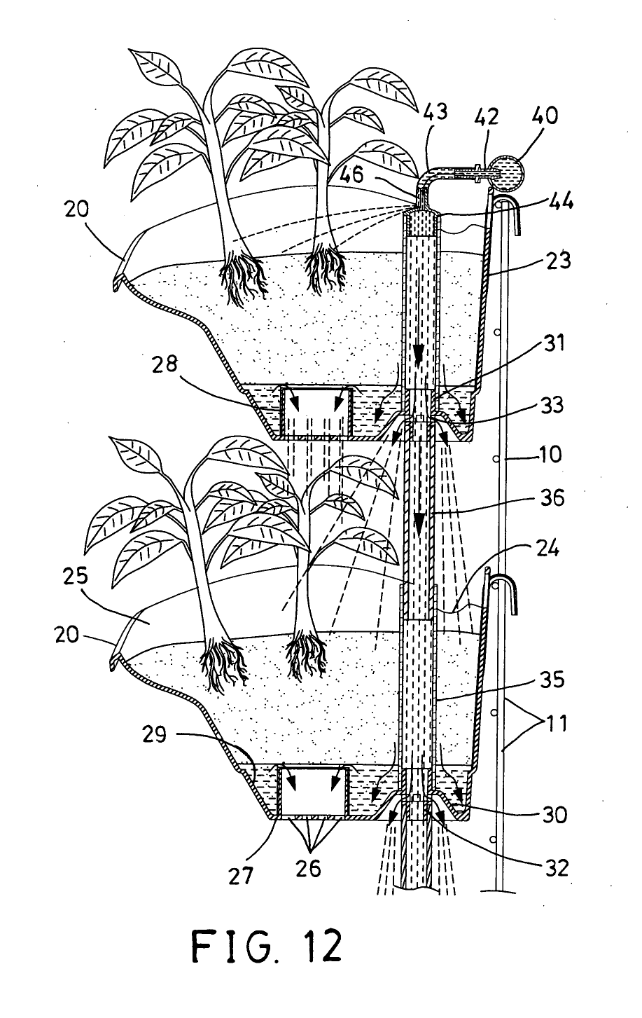

The planter pots 20 each include an engaging notch 24 formed in top of each of the side walls 25 thereof for selectively receiving or engaging with a water supplying pipe 40 or the like, and each include a number of openings 26 formed in the bottom wall 27 thereof for allowing the water to selectively flow downwardly and to flow out through the openings 26 of the bottom wall 27 (FIG. 12), and each include a casing or peripheral fence 28 extended upwardly from the bottom wall 27 and disposed or located or arranged around the openings 26 of the bottom wall 27 for forming or defining a chamber 29 in the planter pot 20 and around the peripheral fence 28 and for receiving or containing or retaining or storing the water within the chamber 29 of the planter pot 20.

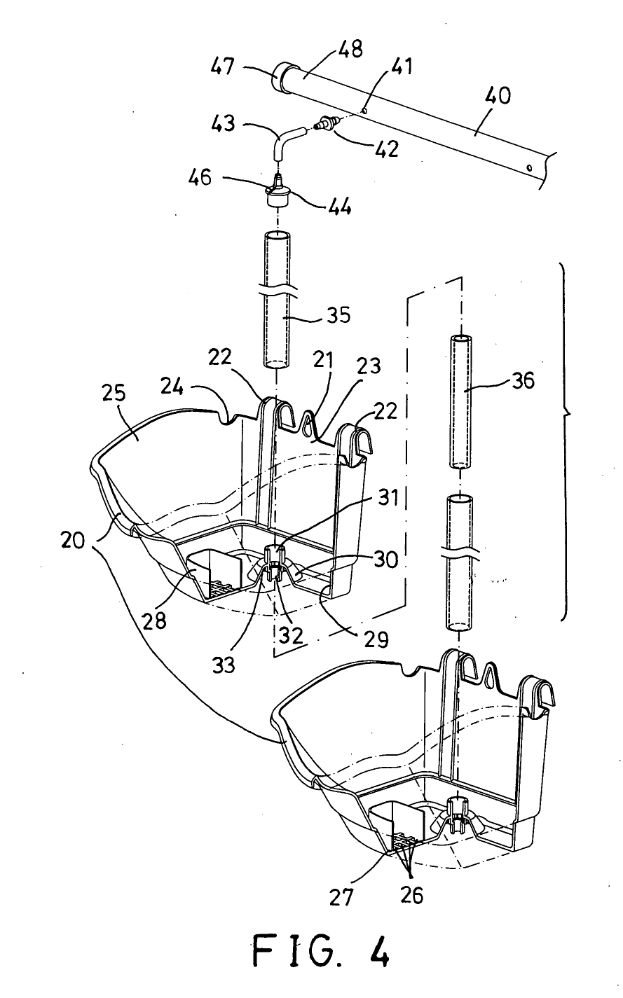

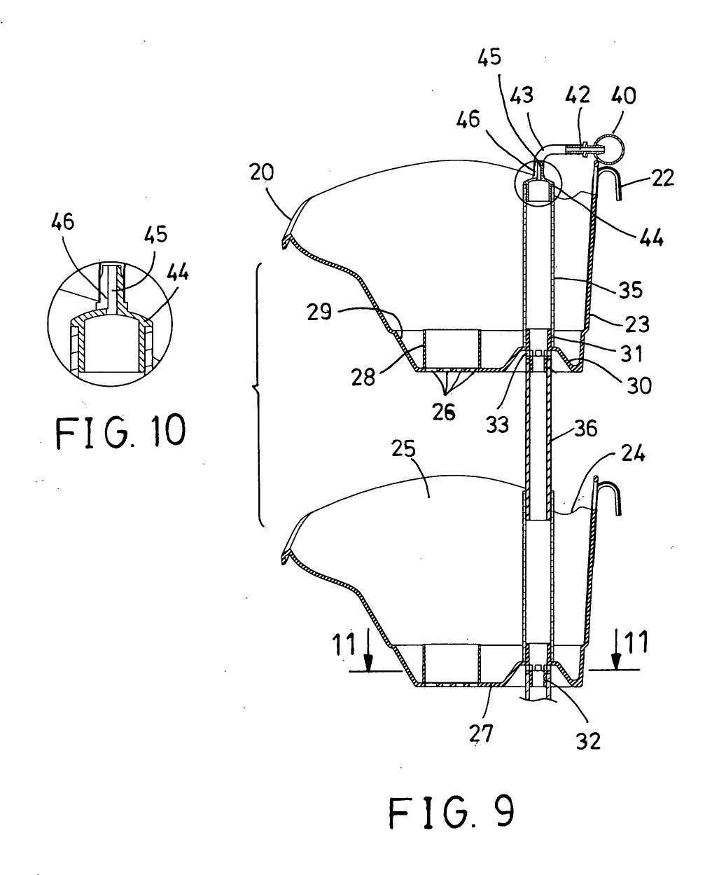

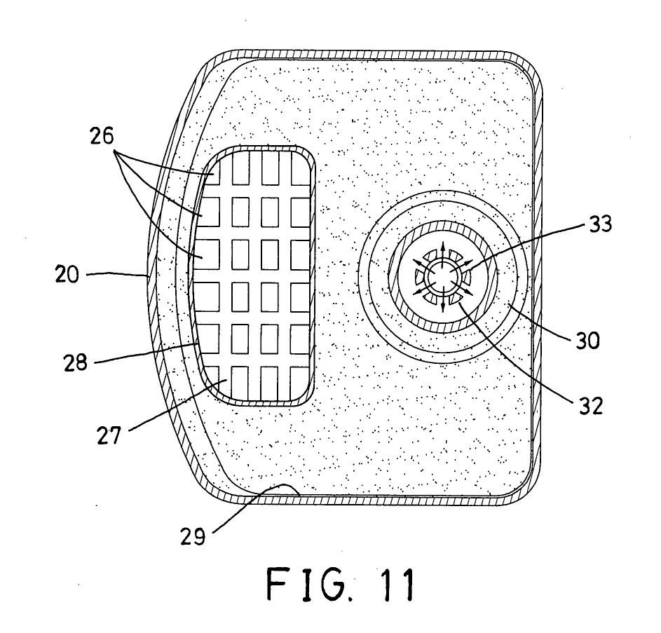

The planter pots 20 each further include a casing or bulge or seat 30 extended upwardly from the bottom wall 27 and spaced from the peripheral fence 28, a port 31 extended upwardly from the seat 30 or from the bottom wall 27, and an outlet conduit 32 extended downwardly from the seat 30 or from the bottom wall 27 and/or received or engaged in the seat 30, in which, it is preferable, but not necessarily that the outlet conduit 32 includes an inner or outer diameter smaller than that of the port 31 (FIGS. 4, 6, 9 and 12), and the outlet conduit 32 includes one or more orifices 33 formed therein (FIGS. 9, 12) for allowing the water to selectively flow downwardly or outwardly and to flow out through the orifices 33 of the outlet conduit 32 (FIG. 12) and to selectively supply the water downwardly to the lower planter pot 20 that is disposed and located below the upper ones. The planter pots 20 each further include a tube 35 attached or engaged onto the port 31 thereof, and a hose 36 engaged or coupled between the tube 35 and the outlet conduit 32 of the upper planter pot 20.

The water supplying pipe 40 may be attached or mounted or secured to the supporting device 10 or supported on the planter pots 20, and includes a number of outlet apertures 41 formed therein for engaging with or for connecting or coupling to the tubes 35 of the upper planter pots 20 indirectly with mouth pieces 42, hoses 43, and/or sprayer nozzles or couplers 44, or directly with the couplers 44, and for supplying the water to the tubes 35 of the upper planter pots 20, in which the couplers 44 each include a bore 45 formed therein and communicative with the tubes 35 and the apertures 41 of the water supplying pipe 40 and the mouth pieces 42, and/or the hoses 43, the water may then flow downwardly through the tubes 35 of the lower planter pots 20 and may then flow through the orifices 33 of the outlet conduit 32 (FIG. 12) to selectively supply the water downwardly to the lower planter pot 20 that is disposed and located below the upper planter pot 20.

The couplers 44 each further include an outlet channel 46 formed therein and communicative with the bore 45 of the coupler 44 for selectively and directly supplying the water out of the coupler 44 and into the upper planter pots 20 (FIG. 12), and the water supplying pipe 40 further includes an end cap 47 attached or mounted or secured a free end 48 of the water supplying pipe 40 for blocking or enclosing the free end 48 of the water supplying pipe 40. As shown in FIG. 1, a coupling or connecting pipe 49 may further be provided and attached or mounted or secured or coupled to the water supplying pipes 40 and may be coupled to a water reservoir (not shown) or the like for supplying the water to the water supplying pipes 40 and then to the upper and the lower planter pots 20. As shown in FIG. 12, the water may be received or contained or retained or stored within the chamber 29 of the planter pot 20 for suitably watering the plants contained in the planter pots 20, and the excess water may flow over the peripheral fence 28 and may selectively flow downwardly and flow out through the openings 26 of the bottom wall 27 to the lower planter pots 20.

In operation, as shown in FIGS. 1 and 12, the water from the water supplying pipes 40 may be suitably supplied to the tubes 35 of the upper planter pots 20, and may then flow downwardly through the tubes 35 of the lower planter pots 20 and may then flow through the orifices 33 of the outlet conduit 32 to selectively supply the water downwardly to the lower planter pot 20 that is disposed and located below the upper planter pot 20, the water from the water supplying pipes 40 may also be suitably or selectively supplied to the upper planter pots 20 with the couplers 44 (FIG. 12), and the excess water may flow over the peripheral fence 28 and may selectively flow downwardly and flow out through the openings 26 of the bottom wall 27 to the lower planter pots 20, such that the large number of the planter pots 20 may be easily and automatically supplied with the water, almost no water will be wasted, such that the water may be economized.

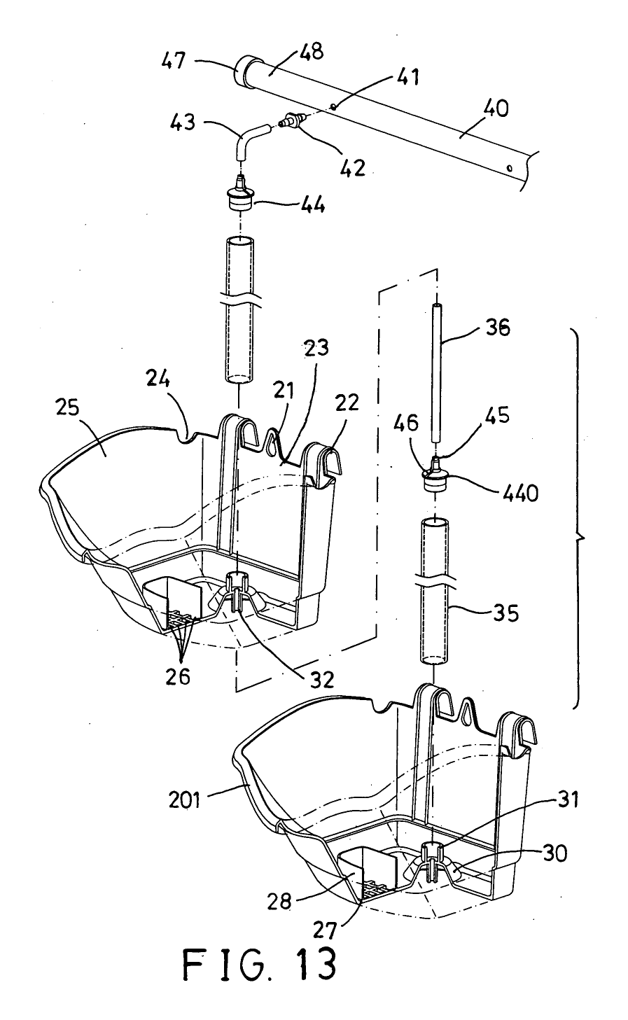

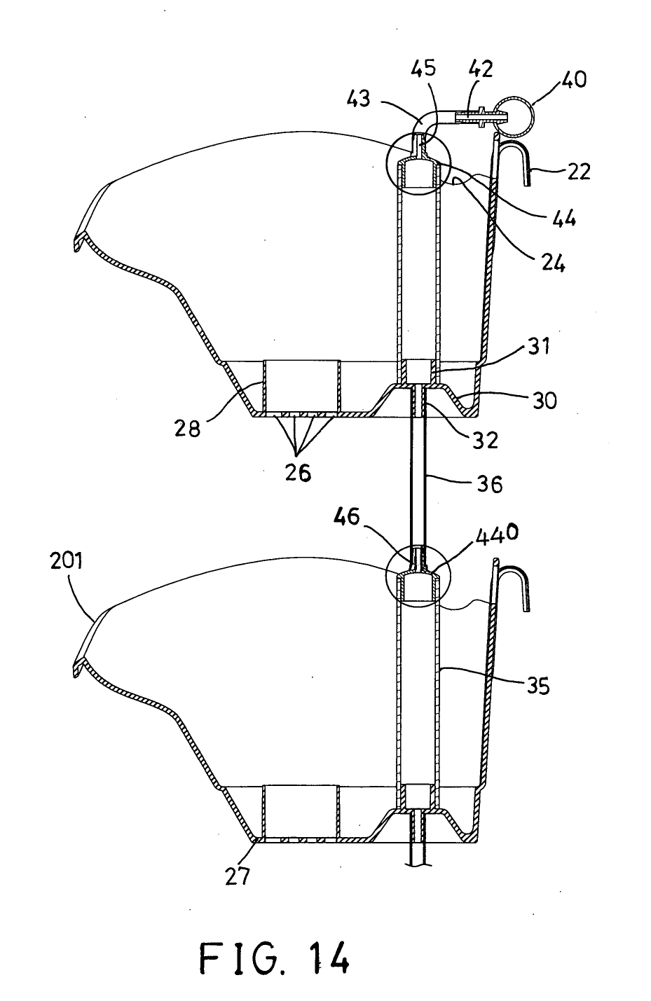

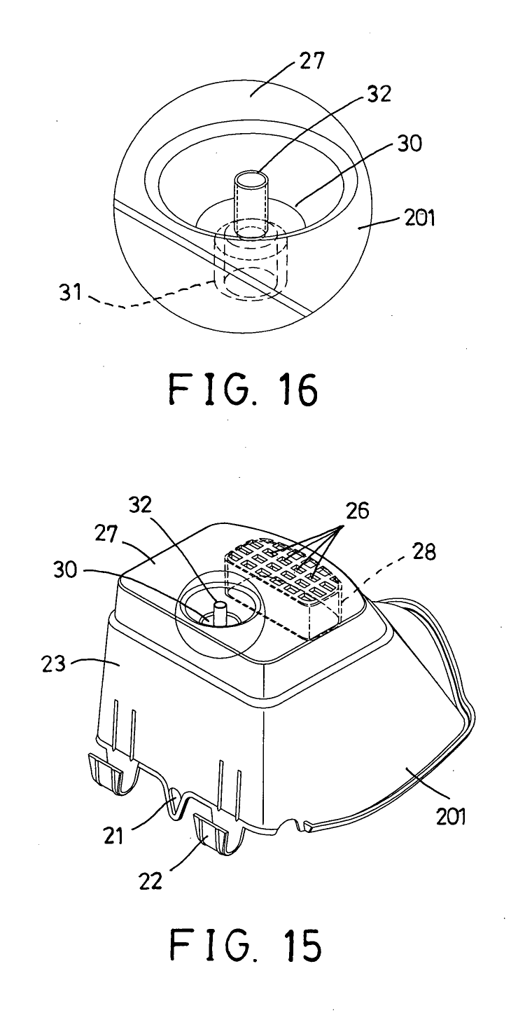

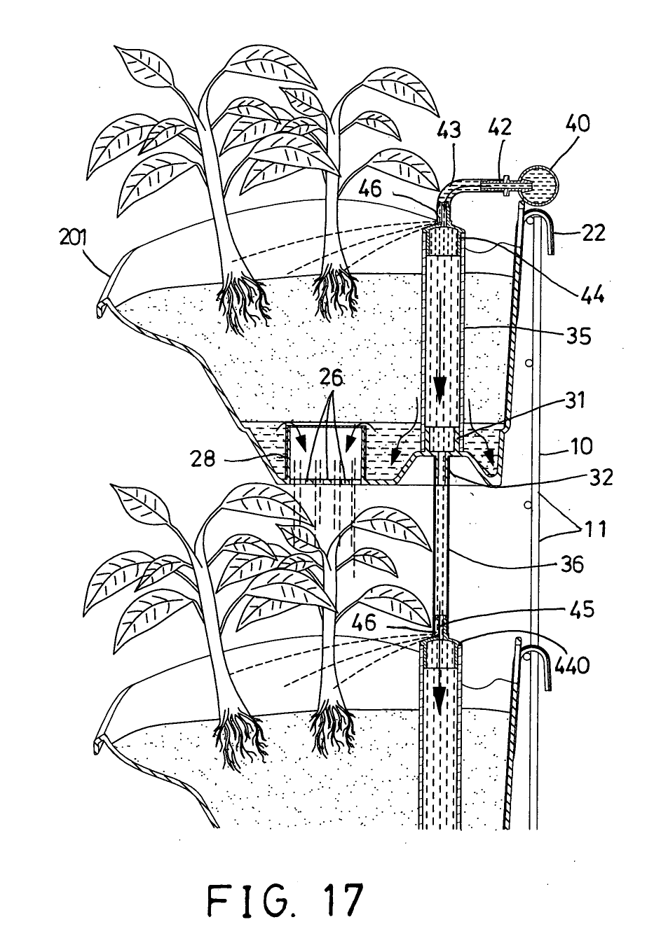

Alternatively, as shown in FIGS. 13-17, the planter pots 201 each may also include a casing or bulge or seat 30 extended upwardly from the bottom wall 27 and spaced from the peripheral fence 28, a port 31 extended upwardly from the seat 30 for connecting or coupling to the tubes 35, and an outlet conduit 32 extended downwardly from the seat 30 and/or received or engaged in the seat 30 for connecting or coupling to the hoses 36. The couplers 44 each also include an outlet channel 46 formed therein and communicative with the bore 45 of the coupler 44 for selectively and directly supplying the water out of the coupler 44 and into the upper planter pots 201. An additional sprayer nozzle or coupler 440 may further be provided and attached or mounted or secured or engaged between the tube 35 and the hose 36 and includes an outlet channel 46 formed therein and communicative with the bore 45 of the coupler 440 for selectively and directly supplying the water out of the coupler 440 and into the lower planter pots 201.

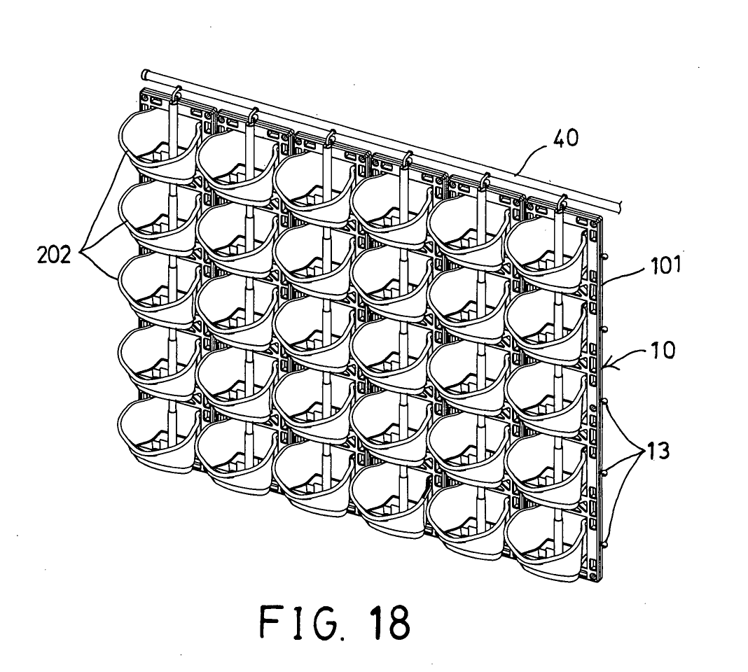

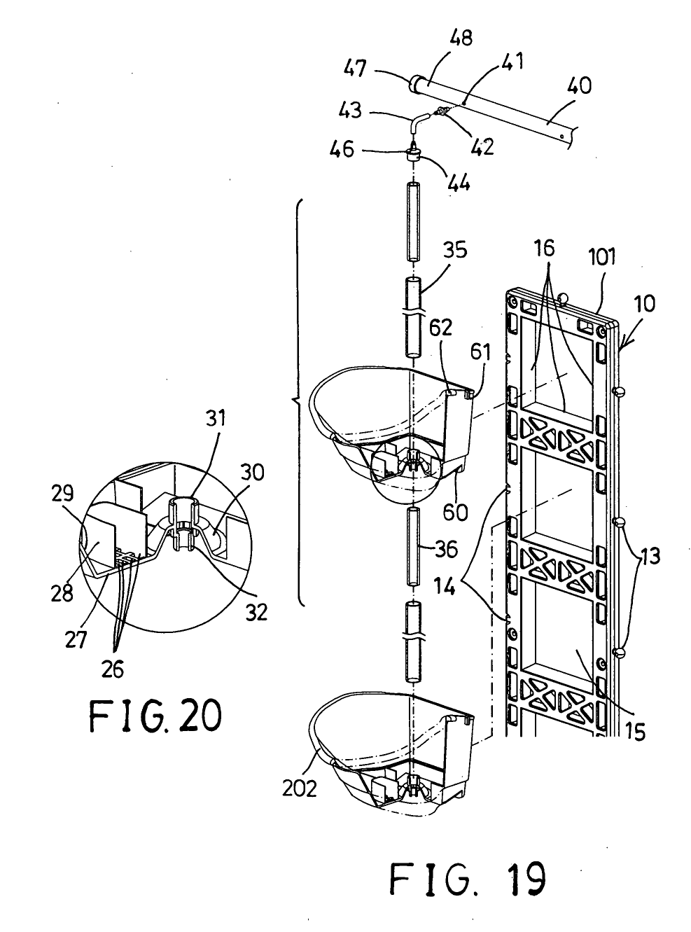

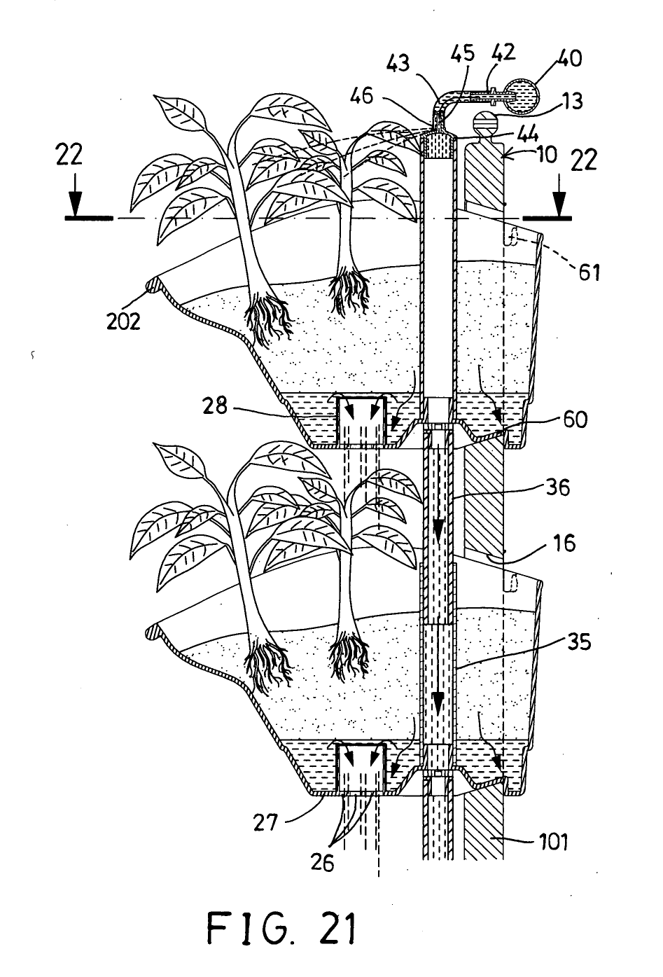

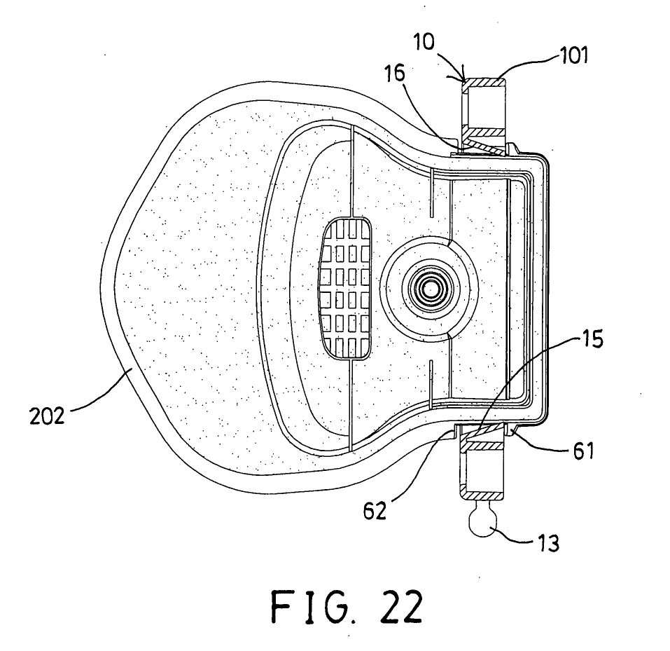

Further alternatively, as shown in FIGS. 18-22, the supporting device 10 may include a number of panels 101 adjustably secured or coupled together to various kinds of shapes or configurations with connectors 13 and socket openings 14, and the panels 101 each include a number of compartments 15 formed therein and formed or defined by tilted or inclined peripheral surfaces 16, the planter pots 202 each may include a lower notch 60 formed therein for engaging with the lower tilted or inclined peripheral surface 16 of the panels 101, one or more anchors 61 for engaging with the panels 101, and one or more locks or catches or latches 62 also for engaging with the panels 101 and for anchoring or securing or retaining the planter pots 202 to the panels 101. The couplers 44 each also include an outlet channel 46 formed therein and communicative with the bore 45 of the coupler 44 for selectively and directly supplying the water out of the coupler 44 and for supplying the water into the upper planter pots 202.

Accordingly, the planter combination in accordance with the present invention includes a number of containers or planter pots and including a watering system for easily and automatically watering the plants contained in the planter pots and for economizing the water.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A planter combination comprising:
a supporting device,
an upper planter pot attached to said supporting device and including a port extended from a bottom wall,
a tube attached to said port of said upper planter pot,
a water supplying pipe, and
a coupler connecting said water supplying pipe to said tube for supplying a water to said tube and said port of said upper planter pot, said coupler including a bore formed therein and communicative with said tube and said water supplying pipe and for allowing the water to flow from said water supplying pipe to said tube, and said coupler including an outlet channel formed therein and communicative with said bore of said coupler for supplying the water out of said coupler and into said upper planter pot.

2. The planter combination as claimed in claim 1, wherein said water supplying pipe includes an outlet aperture formed therein and connected to said coupler with a mouth piece and a hose.

3. The planter combination as claimed in claim 1, wherein said upper planter pot includes a bottom wall having a plurality of openings formed therein for allowing the water to flow out through said openings of said bottom wall, and includes a peripheral fence extended upwardly from said bottom wall and arranged around said openings of said bottom wall for forming a chamber in said planter pot and around said peripheral fence and for receiving and containing said water within said chamber of said planter pot and for allowing an excess water to flow over said peripheral fence and to selectively flow out through said openings of said bottom wall.

4. The planter combination as claimed in claim 3 further comprising a lower planter pot attached to said supporting device and disposed below said upper planter pot, and said lower planter pot including a port extended from a bottom wall and connected to a second tube, and said upper planter pot including an outlet conduit extended downwardly therefrom and connected to said second tube.

5. The planter combination as claimed in claim 4, wherein said outlet conduit of said upper planter pot includes at least one orifice formed therein for allowing the water to selectively flow out through said at least one orifice of said outlet conduit and to flow to said lower planter pot.

6. The planter combination as claimed in claim 4, wherein said upper and said lower planter pots each include a seat extended from said bottom wall, and said outlet conduit is extended from said seat.

7. The planter combination as claimed in claim 1, wherein said upper and said lower planter pots each include at least one hook member for engaging with said supporting device.

8. The planter combination as claimed in claim 7, wherein said supporting device includes a plurality of grids provided therein for engaging with said at least one hook member of said upper and said lower planter pots.

9. The planter combination as claimed in claim 1, wherein said supporting device includes a plurality of panels each having a plurality of compartments formed therein and defined by inclined peripheral surfaces for engaging with and for supporting said upper planter pot.
